(19) United States
(12) Patent Application Publication
(10) Pub. No.: US 2019/0153291 A1
(43) Pub. Date: May 23, 2019

(54) HIGH DENSITY MICROFINE CEMENT FOR SQUEEZE CEMENTING OPERATIONS

(71) Applicant: Saudi Arabian Oil Company, Dhahran (SA)

(72) Inventors: Abdullah Al-Yami, Dhahran (SA); Vikrant Wagle, Abqaiq (SA); Zainab Alsaihati, Saihat (SA)

(21) Appl. No.: 15/819,863

(22) Filed: Nov. 21, 2017

(51) Int. Cl. C09K 8/48; C04B 28/02; C04B 14/30; E21B 33/138

(52) U.S. Cl. CPC C09K 8/48; C04B 28/02; C04B 2201/20; E21B 33/138; C04B 14/30

(57) ABSTRACT

A method for performing remedial cementing operations in a subterranean well includes providing a high density microfine cement composition, the composition having a microfine cement, and a manganese tetraoxide and having a density in a range of 145 to 165 pcf. The high density microfine cement composition is injected into a high pressure zone of the subterranean well. The high density microfine cement composition is pumped into a low injectivity zone of the subterranean well.

### BACKGROUND OF THE DISCLOSURE

### 1. Field of the Disclosure

This disclosure relates generally to remedial cementing operations, and more particularly to squeeze cementing operations in high pressure zones of subterranean wells.

### 2. Description of the Related Art

Squeeze cementing operations can be used for performing remedial cementing operations in subterranean wells. In squeeze cementing operations, a cement slurry is injected under pressure into an interval of interest within the subterranean well. Squeeze operations can be used, for example, for addressing fluids leaks such as the passage of oil, gas, or water through small openings. Such openings may include, for example, cracks in well tubular members such as well casing, holes or other unwanted spaces in or around cement that surrounds the casing, and unwanted fluid flow paths through a gravel pack or through the formation itself.

### SUMMARY OF THE DISCLOSURE

Embodiments of this disclosure provide high density microfine cement formulations for remedial squeeze cementing operations. Methods and compositions disclosed in this disclosure use a weighting agent composed of manganese tetraoxide (Mn₃O₄) in a microfine cement slurry. The composition used for filling the openings should have a particle size that will fit within the opening to be filled. If the particle size is too large, the composition cannot enter the opening and could instead form a weak patch over the opening. Some current compositions that can be used in areas where there is high injectivity due to the small size of the openings can't be used in zones with elevated pressure because such compositions often have insufficient density.

In an embodiment of this disclosure, a method for performing remedial cementing operations in a subterranean well includes providing a high density microfine cement composition, the composition having a microfine cement, and a manganese tetraoxide and having a density in a range of 145 to 165 pounds per cubic foot (pcf). The high density microfine cement composition is injected into a high pressure zone of the subterranean well. The high density microfine cement composition is pumped into a low injectivity zone of the subterranean well.

In alternate embodiments, the high density microfine cement composition can be substantially free of a cement having a particle size larger than 10 microns (μm). The manganese tetraoxide can have a particle size in the range of 2 to 12 μm. The low injectivity zone can have an injectivity factor greater than 6000 pounds per square inch times minutes per barrel (psi×min/bbl). The high pressure zone can have a pressure greater than 6000 pounds per square inch (psi) before the high density microfine cement composition is injected into the high pressure zone. The manganese tetraoxide of the high density microfine cement composition can be in an amount in the range of 160-400% by weight of microfine cement (% BWOC) or alternately in an amount in the range of 180-200% BWOC. The high density microfine cement composition can have a plastic viscosity in the range of 74 centipoise (cP) measured at a temperature of 90 degrees Fahrenheit (° F.) to 152 cP measured at a temperature of 190° F.

In an alternate embodiment of the disclosure, a high density microfine cement composition includes a microfine cement and a manganese tetraoxide and has a density in a range of 145 to 165 pcf.

In alternate embodiments, the high density microfine cement composition can be substantially free of a cement having a particle size larger than 10 μm. The manganese tetraoxide can have a particle size in the range of 2 to 12 μm. The manganese tetraoxide of the high density microfine cement composition can be in an amount in the range of 160-400% BWOC or alternately can be in an amount in the range of 180-200% BWOC. The high density microfine cement composition can have a plastic viscosity in the range of 74 cP measured at a temperature of 90° F. to 152 cP measured at a temperature of 190° F.

### BRIEF DESCRIPTION OF THE DRAWINGS

So that the manner in which the previously-recited features, aspects and advantages of the embodiments of this disclosure, as well as others that will become apparent, are attained and can be understood in detail, a more particular description of the disclosure briefly summarized previously may be had by reference to the embodiments that are illustrated in the drawings that form a part of this specification. It is to be noted, however, that the appended drawings illustrate only certain embodiments of the disclosure and are, therefore, not to be considered limiting of the disclosure's scope, for the disclosure may admit to other equally effective embodiments.

FIG. 1 is a schematic section view of a subterranean well with a system for injecting a high density microfine cement composition, in accordance with an embodiment of this disclosure.

FIG. 2 is a graph showing performance results of a high density microfine cement composition of an embodiment of this disclosure.

### DETAILED DESCRIPTION OF THE DISCLOSURE

The disclosure refers to particular features, including process or method steps. Those of skill in the art understand that the disclosure is not limited to or by the description of embodiments given in the specification. The subject matter is not restricted except only in the spirit of the specification and appended Claims.

Those of skill in the art also understand that the terminology used for describing particular embodiments does not limit the scope or breadth of the embodiments of the disclosure. In interpreting the specification and appended Claims, all terms should be interpreted in the broadest possible manner consistent with the context of each term. All technical and scientific terms used in the specification and appended Claims have the same meaning as commonly understood by one of ordinary skill in the art to which this disclosure belongs unless defined otherwise.

As used in the Specification and appended Claims, the singular forms “a”, “an”, and “the” include plural references unless the context clearly indicates otherwise.

As used, the words “comprise,” “has,” “includes”, and all other grammatical variations are each intended to have an open, non-limiting meaning that does not exclude additional elements, components or steps. Embodiments of the present disclosure may suitably “comprise”, “consist” or “consist essentially of” the limiting features disclosed, and may be practiced in the absence of a limiting feature not disclosed. For example, it can be recognized by those skilled in the art that certain steps can be combined into a single step.

Where a range of values is provided in the Specification or in the appended Claims, it is understood that the interval encompasses each intervening value between the upper limit and the lower limit as well as the upper limit and the lower limit. The disclosure encompasses and bounds smaller ranges of the interval subject to any specific exclusion provided.

Where reference is made in the specification and appended Claims to a method comprising two or more defined steps, the defined steps can be carried out in any order or simultaneously except where the context excludes that possibility.

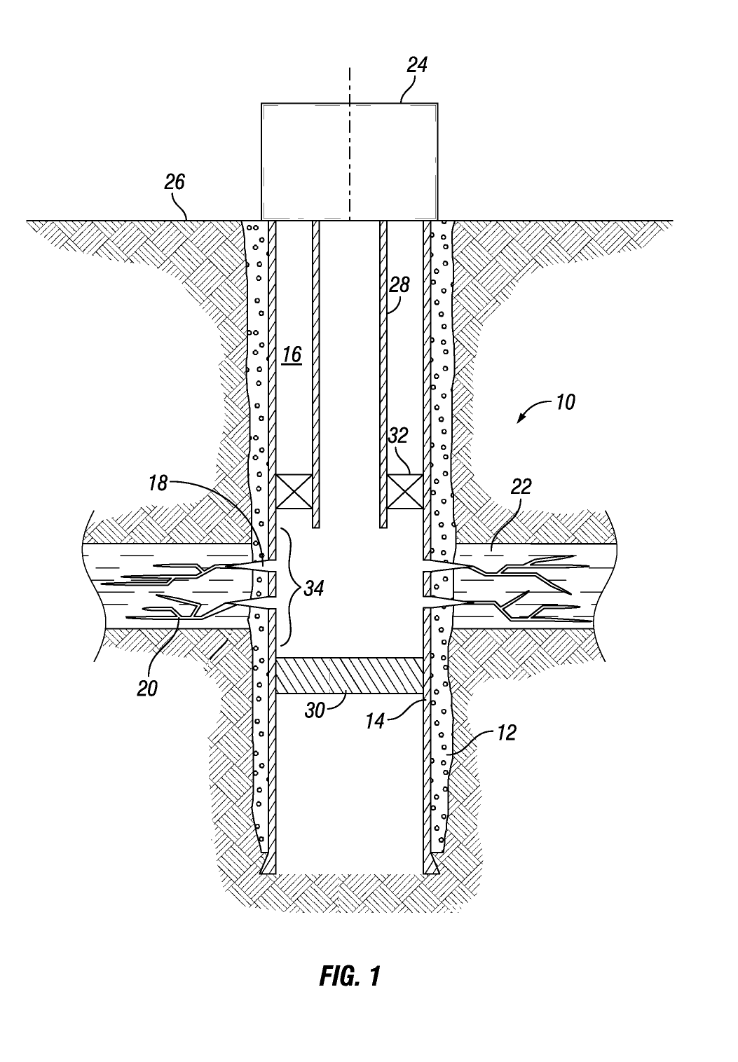

Looking at FIG. 1, subterranean well 10 can be a subterranean well used in hydrocarbon production operations. Subterranean well 10 can be a production well or an injection well. Subterranean well 10 can be lined with cement 12 and casing 14 in a manner known in the art. Subterranean well 10 can be a vertical cased well, as shown, or can be open hole or can be angled or slanted, horizontal, or can be a multilateral well. Subterranean well 10 can have a wellbore 16 that can be an inner bore of casing 14. Perforations 18 can extend through the sidewall of casing 14 and through cement 12. Perforations 18 can be in fluid communication with fractures 20 that extend into subterranean formation 22. Subterranean formation 22 can contain a fluid such as a liquid or gaseous hydrocarbon, water, steam, or a combination of a liquid or gaseous hydrocarbon, water, or steam. The fluid within subterranean formation 22 can pass through perforations 18 and into subterranean well 10.

FIG. 1 shows only one set of perforations 18 into one subterranean formation 22. In alternate embodiments there may be additional subterranean formations 22 and casing 14 can include additional sets of perforations 18 through casing 14 into such additional subterranean formations 22. A wellhead assembly 24 can be located at surface 26, such as an earth's surface or a seabed, at an upper end of subterranean well 10.

During the life of subterranean well 10, it may be desirable to perform remedial cementing operations on subterranean well 10 to plug small openings with the systems of subterranean well 10 to block the flow of fluids through such openings. As an example, an operator may wish to plug all or a portion of openings cracks in well tubular members such as well casing 14, holes or other unwanted spaces in or around cement 12 that surrounds casing 14, or unwanted fluid flow paths through a gravel pack (not shown) or formation 22. The remediation can be performed by squeeze cementing operations.

In squeeze cementing operations a cement composition is injected into subterranean well 10. Sufficient pressure is applied to the cement composition so that the cement composition is squeezed into the openings to be plugged. In certain high pressure squeeze operations, the squeeze pressure can be in excess of the pressure required to fracture subterranean formation 22.

In embodiments of this disclosure, the squeeze cementing operations can be performed by currently known methods. As an example, the cement composition can be injected through an inner tubular member 28. Bottom packer 30 can limit the depth of travel of the cement composition. Bottom packer 30 can be for example, a bridge plug or other sealing device known in the industry. Bottom packer 30 can sealingly engage an inner diameter surface of casing 14 to prevent fluids from traveling past bottom packer 30. Top packer 32 can provide an second boundary for limiting the travel of the cement composition. Top packer 32 can sealinging engage both an outer diameter surface of tubular member 28 and the inner diameter surface of casing 14 to prevent fluids from traveling past top packer 32.

After a sufficient volume of cement composition has been injected into subterranean well 10, a squeeze pressure can be applied to the cement composition. The squeeze pressure can be applied, for example, with a displacement fluid that is pumped into subterranean well 10. A slurry that contains excess cement composition can be circulated back to the surface.

In order to perform the remedial cementing operations in subterranean well 10, a high density microfine cement composition in accordance with embodiments of this disclosure can be used. Embodiments of the current application are suitable for plugging microfine openings. As an examples, high density microfine cement compositions of embodiments of this disclosure can be used to fill openings with dimensions in the range of 0.5 μm to 15 μm. When performing squeeze cement operations with openings that have such micofine openings, injection zone 34 is considered to be a low injectivity zone. As an example injection zone 34 of subterranean well 10 can have an injectivity factor greater than 6000 psi×min/bbl.

Embodiments of the high density microfine cement composition can be used for remedial operations performed in injection zone 34 which is a high pressure zone of subterranean well 10. As an example, injection zone 34 can be a zone of subterranean well 10 that has pressure in greater than 6000 psi before the high density microfine cement composition is injected into injection zone 34. In certain embodiments, after the high density microfine cement is used to remediate subterranean well 10, the pressure within high pressure zone can be reduced. As an example, the pressure within high pressure zone can be reduced to a range of about 50 psi to 10,000 psi.

In order to be used in a high pressure zone of subterranean well 10, the high density microfine cement composition can have a density in a range of 120 to 165 pcf. The density of cement slurry is selected based on the formation pressure. For high pressure zones, a higher density is required to control the formation pressure. The microfine particles will penetrate inside micro-cracks of the formation for deeper penetration. If the density of the cement slurry in not high enough to control the formation pressure, or if the density of the cement slurry is lower than the formation pressure then the cementing operation will fail. The slurry density can be converted to a pressure by multiplying the density of the cement by the depth and by a conversion factor. As an example, the slurry pressure (P) can be calculated by the formula:

P=MW×Depth×0.052;

where MW is the drilling fluid density in pounds per gallon, Depth is the true vertical depth or “head” in feet, and 0.052 is a unit conversion factor chosen such that P results in units of pounds per square

The high density microfine cement composition includes a microfine cement, and a manganese tetraoxide. In certain embodiments, the manganese tetraoxide of the high density microfine cement is in an amount in the range of 160-400% BWOC. In alternate embodiments, the manganese tetraoxide of the high density microfine cement composition is in an amount of 180-200% BWOC or the manganese tetraoxide of the high density microfine cement composition is in an amount of 200-400% BWOC.

The microfine cement is free of a cement having a particle size larger than 10 μm. As used herein, the term “substantially free of” as it relates to the microfine cement means a level of less than one percent by weight of the microfine cement. The manganese tetraoxide has a particle size in the range of 0.5 to 12 μm. Using a microfine cement and a manganese tetraoxide with such particle sizes allows for the use of the high density microfine cement composition in a low injectivity zone. Having a cement or a weighting agent with a larger particle size would reduce the effectiveness of the cement composition in low injectivity zones. If the particle size of the cement or weighting agent is too large, the cement composition will not enter the openings. Instead, a weak patch maybe formed over the opening which is likely to fail.

The high density microfine cement composition can further include suitable additives, the amounts of which will depend on the characteristics of the particular subterranean well 10 to be remediated. As an example, the additives can include an antifoam agent, a fluid loss additive, a dispersant, a retarder, or any combination of such additives. In example embodiments, the antifoam agent can be in an amount in a range of 0.01-0.09 gallons per sack (gps), the fluid loss additive can be in an amount in a range of 0.01-0.9 for a solid fluid loss additive % BWOC and 0.01-0.09 gps for a liquid fluid loss additive, the dispersant can be in an amount in a range of 0.01-0.9% BWOC for a solid dispersant additive and 0.01-0.09 gps for a liquid dispersant additive, and the retarder can be in an amount in a range of 0.01-0.9% BWOC for a solid retarder additive and 0.01-0.09 gps for a liquid retarder additive.

In order to be useful in high pressure low injectivity zones, the high density microfine cement composition has a plastic viscosity in the range of 74 cP measured at a temperature of 90° F. to 152 cP measured at a temperature of 190° F. In alternate embodiments, the viscosity can be in a range of 60-180 cP. Such a range of viscosities provides for the suspension of cement and solids within the liquids of the composition without settling of the cement and solids out of the liquid phase. Viscosity of cement is important because it determines how cement will be easy to pump or not. The fluid loss of the high density microfine cement composition is less than 50 Milliliters per 30 minutes. A fluid loss within this range will ensure that the slurry will remain as a solution and fluid will be separated or lost from the slurry.

### Experimental Results

In order to determine the performance of the high density microfine cement composition, two sample compositions were formed and tested in a laboratory environment. The example cement composition slurries were tested for rheology, thickening time, fluid loss, and free water in order to evaluate the performance of each cement composition slurry.

The sample high density microfine cement compositions were prepared according to API Recommended Practice 10-B (American Petroleum Institute, 2015). The weight of each component is measured using a balance. Solid particles are blended together to form a homogenous mixture. Water and other liquid additives are mixed at low shear rate using an American Petroleum Institute mixer. The solid blend is added to liquid additives at a rate of 4000 revolutions per minute (rpm). The mixture is sheared at a rate of 12,000 rpm.

The particle size of manganese tetraoxide used in the example compositions had a size distribution with 10% of the particles having a particle size of 2.665 μm or less, 50% of the particles having a particle size of 5.308 μm or less, and 90% of the particles having a particle size of 10.383 μm or less.

Table 1 shows the amounts of the components of the first example cement composition, Composition I.

TABLE 1
Example Composition I

| Component | Concentration | Unit Of Measure |
|---|---|---|
| Microfine Cement | 100 | % BWOC |
| Mn₃O₄ | 200 | % BWOC |
| Antifoam | 0.015 | gps |
| Fluid loss additive | 0.2 | % BWOC |
| Dispersant | 0.8 | % BWOC |
| Retarder 1 | 1.5 | % BWOC |
| Retarder 2 | 0.2 | % BWOC |

Rheology tests were performed on Composition I at 90° F. and 145° F. The results of such tests are shown in Table 2 and Table 3, respectively.

TABLE 2
Rheology Results of Composition I at 90° F.
Rheology at 90° F.

| RPM | Measurement |
|---|---|
| 300 | 121 |
| 200 | 97 |
| 100 | 71 |
| 60 | 61 |
| 30 | 53 |
| 6 | 52 |
| 3 | 48 |
| Plastic Viscosity/Yield Pressure | 74 cP/50 lb/100 ft² |

TABLE 3
Rheology Results of Composition I at 145° F.
Rheology at 145° F.

| RPM | Measurement |
|---|---|
| 300 | 90 |
| 200 | 68 |
| 100 | 36 |
| 60 | 24 |
| 30 | 16 |
| 6 | 13 |
| 3 | 11 |
| Plastic Viscosity/Yield Pressure | 82 cP/10 lb/100 ft² |

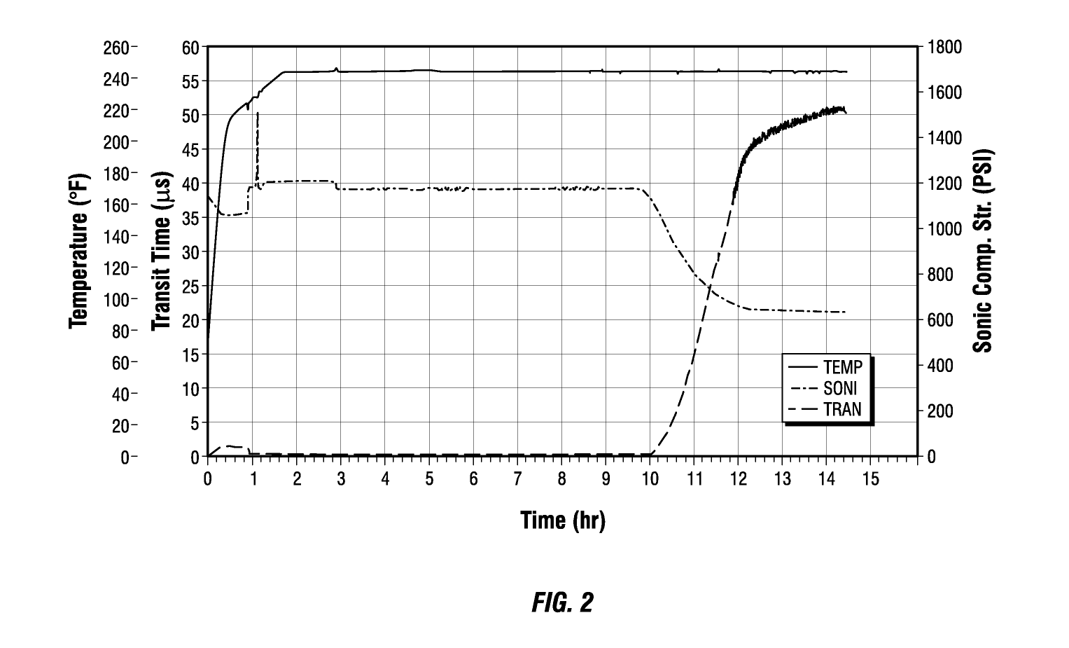

FIG. 2 provides a thickening time chart for example Composition I. The thickening time or pumping time is determined from the operation time and cement formulations can be selected to achieve the desired thickening time, pumping time, and setting time. For typical cementing operations the target thickening time is 1-12 hours.

Table 4 shows the amounts of the components of the first example cement composition, Composition II.

TABLE 4
Example Composition II

| Component | Concentration | UOM |
|---|---|---|
| Weighting agent | 180 | % BWOC |
| Antifoam | 0.035 | gps |
| Dispersant | 0.90 | % BWOC |
| Gas migration control additive | 3.7 | gps |
| Gas migration control additive | 0.25 | gps |
| High Temperature | | |
| Retarder | 0.60 | % BWOC |
| Fluid loss | 0.20 | gps |

Rheology tests were performed on Composition II at 80° F. and 190° F. The results of such tests are shown in Table 5 and Table 6, respectively.

TABLE 5
Rheology Results of Composition II at 80° F.

| Rheology: T = 80 F. | Ramp Up | Ramp Down | Average |
|---|---|---|---|
| 300 | 175 | 175 | 175 |
| 200 | 145 | 143 | 144 |
| 100 | 88 | 85 | 87 |
| 60 | 63 | 59 | 61 |
| 30 | 43 | 41 | 42 |
| 6 | 20 | 19 | 20 |
| 3 | 16 | 15 | 16 |

TABLE 6
Rheology Results of Composition II at 190° F.

| Rheology: T = 190 F. | Ramp Up | Ramp Down | Average |
|---|---|---|---|
| 300 | 143 | 143 | 143 |
| 200 | 105 | 103 | 104 |
| 100 | 65 | 66 | 66 |
| 60 | 47 | 48 | 48 |
| 30 | 33 | 37 | 35 |
| 6 | 16 | 23 | 20 |
| 3 | 8 | 20 | 14 |

| | |
|---|---|
| Gel strength | 11/48 |
| (10 sec/10 min) | |
| lb/100 ft² | |
| Plastic Viscosity/ | 152 cP/32 lb/100 ft² |
| Yield Pressure | |

Additional tests were performed on Composition II to determine the thickening time, free fluid, and fluid loss of Composition II. The results of such tests are shown in Table 7.

TABLE 6
Additional Testing of Composition II
Thickening time

| Consistency | Time |
|---|---|
| 70 Bc | 7:15 hrs |
| 100 Bc | 8:00 hrs |

Free Fluid
0 ml/250 ml in 2 hrs
25 C., 0 deg inclination
No sedimentation
Fluid loss
API fluid loss 44 ml
30 min, 97 C., and 1000 psi

Embodiments of the disclosure described, therefore, are well adapted to carry out the objects and attain the ends and advantages mentioned, as well as others that are inherent. While example embodiments of the disclosure have been given for purposes of disclosure, numerous changes exist in the details of procedures for accomplishing the desired results. These and other similar modifications will readily suggest themselves to those skilled in the art, and are intended to be encompassed within the spirit of the present disclosure and the scope of the appended claims.

What is claimed is:

1. A method for performing remedial cementing operations in a subterranean well, the method including:
providing a high density microfine cement composition, the composition having a microfine cement, and a manganese tetraoxide and having a density in a range of 145 to 165 pcf;
injecting the high density microfine cement composition into a high pressure zone of the subterranean well;
pumping the high density microfine cement composition into a low injectivity zone of the subterranean well.

2. The method of claim 1, where the high density microfine cement composition is substantially free of a cement having a particle size larger than 10 μm.

3. The method of claim 1, where the manganese tetraoxide has a particle size in the range of 2 to 12 μm.

4. The method of claim 1, where the low injectivity zone has an injectivity factor greater than 6000 psi×min/bbl.

5. The method of claim 1, where the high pressure zone has pressure greater than 6000 psi before the high density microfine cement composition is injected into the high pressure zone.

6. The method of claim 1, where the manganese tetraoxide of the high density microfine cement composition is in an amount in the range of 160-400% BWOC.

7. The method of claim 1, where the manganese tetraoxide of the high density microfine cement composition is in an amount in the range of 180-200% BWOC.

8. The method of claim 1, where the high density microfine cement composition has a plastic viscosity in the range of 74 cP measured at a temperature of 90° F. to 152 cP measured at a temperature of 190° F.

9. A high density microfine cement composition, the composition having a microfine cement and a manganese tetraoxide and having a density in a range of 145 to 165 pcf.

10. The composition of claim 9, where the high density microfine cement composition is substantially free of a cement having a particle size larger than 10 μm.

11. The composition of claim 9, where the manganese tetraoxide has a particle size in the range of 2 to 12 μm.

12. The composition of claim 9, where the manganese tetraoxide of the high density microfine cement composition is in an amount in the range of 160-400% BWOC.

13. The composition of claim 9, where the manganese tetraoxide of the high density microfine cement composition is in an amount in the range of 180-200% BWOC.

14. The composition of claim 9, where the high density microfine cement composition has a plastic viscosity in the range of 74 cP measured at a temperature of 90° F. to 152 cP measured at a temperature of 190° F.
